(19) United States
(12) Patent Application Publication
(10) Pub. No.: US 2017/0195677 A1
(43) Pub. Date: Jul. 6, 2017

(54) Method of Intra Block Copy with Flipping for Image and Video Coding

(71) Applicant: MediaTek Inc., Hsin-Chu (TW)

(72) Inventors: Jing YE, San Jose, CA (US); Shan LIU, San Jose, CA (US); Xiaozhong XU, Fremont, CA (US)

(21) Appl. No.: 15/308,722

(22) PCT Filed: May 22, 2015
(86) PCT No.: PCT/CN2015/079548

§ 371 Date: Nov. 3, 2016

Related U.S. Application Data
(60) Provisional application No. 62/001,800, filed on May 22, 2014.
(60) Provisional application No. 62/011,847, filed on Jun. 13, 2014.
(60) Provisional application No. 62/026,080, filed on Jul. 18, 2014.
(60) Provisional application No. 62/045,625, filed on Sep. 4, 2014.

(51) Int. Cl. H04N 19/159; H04N 19/11; H04N 19/70; H04N 19/463; H04N 19/593; H04N 19/96; H04N 19/34; H04N 19/176

(52) U.S. Cl. CPC H04N 19/159; H04N 19/34; H04N 19/11; H04N 19/176; H04N 19/463; H04N 19/593; H04N 19/96; H04N 19/70

(57) ABSTRACT

A method and apparatus for video coding including an IntraBC (Intra-block copy) mode with flipping for prediction unit (PU) with a non-2N×2N partition size is disclosed. An IntraBC mode is selected from a mode group comprising a normal IntraBC mode and a flipping mode for a current PU with a current PU size belonging to a size group including at least one PU size selected from 2N×N, N×2N and N×N and N is a positive integer. When the IntraBC mode is used for the current PU, a flipping flag is signaled in a current PU-level syntax to indicate whether the current PU is coded using the flipping mode. Furthermore, when the current PU is coded using the flipping mode, a flip-direction flag is signaled in the current PU-level syntax to indicate a flipping direction of a corresponding flipped reference block.

### CROSS REFERENCE TO RELATED APPLICATIONS

The present invention claims priority to U.S. Provisional Patent Application, Ser. No. 62/001,800, filed on May 22, 2014, U.S. Provisional Patent Application, Ser. No. 62/011,847, filed on Jun. 13, 2014, U.S. Provisional Patent Application, Ser. No. 62/026,080, filed on Jul. 18, 2014 and U.S. Provisional Patent Application, Ser. No. 62/045,625, filed on Sep. 4, 2014. The U.S. Provisional patent applications are hereby incorporated by reference in their entireties.

### TECHNICAL FIELD

The present invention relates to video coding using Intra-block copy (IntraBC) mode. In particular, the present invention relates to techniques to improve the performance of the Intra-block copy (IntraBC) coding mode with flipping for screen content coding or video coding.

### BACKGROUND

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. In three-dimensional and multi-view coding systems, the texture data as well as depth data are coded.

Currently, extensions of HEVC (High Efficiency Video Coding) are being developed, including range extensions (RExt) and 3D extensions. The range extension targets at non-4:2:0 color formats, such as 4:2:2 and 4:4:4, and video data with higher bit-depths such as 12, 14 and 16 bit-per-sample while the 3D extension targets at the coding of multi-view video with depth data.

During the Course of RExt development, various video coding tools have been described, including the “Intra picture block copy” (IntraBC) technique. The IntraBC technique was first disclosed in JCTVC-M0350 (Budagavi et al., AHG8. Video coding using Intra motion compensation, Joint Collaborative Team on Video Coding (JCT-VC) of ITU-T SG16 WP3 and ISO/IEC JTC 1/SC 29/WG11 13th Meeting: Incheon, KR, 18-26 Apr. 2013, Document: JCTVC-M0350). An example according to JCTVC-M0350 is shown in FIG. 1, where a current coding unit (CU, 110) is coded using Intra MC (motion compensation). The prediction block (120) is located from the current CU and a displacement vector (112). In this example, the search area is limited to the current CTU (coding tree unit), the left CTU and the left-left CTU. The prediction block is obtained from the already reconstructed region. Then, the displacement vector, also named motion vector (MV) or block vector (BV), and residual for the current CU are coded. It is well known that the HEVC adopts CTU and CU block structure as basic units for coding video data. Each picture is divided into CTUs and each CTU is reclusively divided into CUs. During prediction phase, each CU may be divided into multiple blocks, named prediction units (PUs) for performing prediction process.

The IntraBC technique of JCTVC-M0350 is later adopted by the RExt draft standard with the modifications disclosed in JCTVC-N0256 (Pang et al., Non-RCE3: Intra Motion Compensation with 2-D MVs, Joint Collaborative Team on Video Coding (JCT-VC) of ITU-T SG16 WP3 and ISO/IEC JTC 1/SC 29/WG11 14th Meeting: Vienna, AT, 25 Jul.-2 Aug. 2013, Document: JCTVC-N0256). Furthermore, a variant of IntraBC, i.e. 2N×M IntraBC is described in JCTVC-O0205 (Chen et al., AHG8. Line-based Intra Block Copy, Joint Collaborative Team on Video Coding (JCT-VC) of ITU-T SG16 WP3 and ISO/IEC JTC 1/SC 29/WG11 15th Meeting: Geneva, CH, 23 Oct.-1 Nov. 2013, Document: JCTVC-O0205). A PU based IntraBC technique is disclosed in JCTVC-P0180 (Chang et al., RCE3: Results of Subtest D.2 on N×2N/2N×N/N×N Intra Block Copy, Joint Collaborative Team on Video Coding (JCT-VC) of ITU-T SG16 WP3 and ISO/IEC JTC 1/SC 29/WG11 16th Meeting: San José, US, 9-17 Jan. 2014, Document: JCTVC-P0180) and was adopted by the HEVC RExt standard.

In JCTVC-Q0035, a further improvement on IntraBC coding by taking into account of symmetry in screen contents (Li et al., Description of screen content coding technology proposal by Microsoft, Joint Collaborative Team on Video Coding (JCT-VC) of ITU-T SG16 WP3 and ISO/IEC JTC 1/SC 29/WG11 17th Meeting: Valencia, ES, 27 March-4 Apr. 2014, Document: JCTVC-Q0035). As shown in FIG. 2, the first row of the predictor is used for predicting the last row of pixels in the current block. The second row of the predictor is used for prediction of the second last row of pixels in the current block, so on and so forth. In JCTVC-Q0035, the signaling of IBC with flipping is embedded in the process of mvd_coding( ) i.e., vector difference coding, as illustrated in the following Table 1. As shown in Table 1, the IntraBC flipping flag (i.e., intra_bc_flip_flag[x0][y0]) in mvd_coding( ).

TABLE 1

| mvd_coding( x0, y0, refList ) { | Descriptor |
|---|---|
| if( refList == 2 ) | |
| intra_bc_flip_flag[ x0 ][ y0 ] | ae(v) |
| abs_mvd_greater0_flag[ 0 ] | ae(v) |
| abs_mvd_greater0_flag[ 1 ] | ae(v) |
| ... | |
| } | |

In JCTVC-Q0082, a further improvement on IntraBC coding by taking into account of symmetry in screen contents (Zhang et al., Symmetric intra block copy, Joint Collaborative Team on Video Coding (JCT-VC) of ITU-T SG16 WP3 and ISO/IEC JTC 1/SC 29/WG11 17th Meeting: Valencia, ES, 27 March-4 Apr. 2014, Document: JCTVC-Q0082). In JCTVC-Q0082), the flipping was extended to horizontal direction, i.e. the first column of the predictor is used for predicting the last column of pixels in the current block, so on. At the same time, the method is constrained to only 2N×2N PU for a given 2N×2N CU. In both JCTVC-Q0035 and JCTVC-Q0082, the block vectors between the current block and the predictor are searched and explicitly signaled. As shown in JCTVC-Q0082, about 2.0% bit-rate reduction for text and graphic contents in YUV format with motion has been demonstrated when the symmetric IntraBC technique is used. In JCTVC-Q0082, the signaling of IBC with flipping is included in CU (coding unit) syntax, as illustrated in Table 2, where a symmetry flag (i.e., symmetric_ibc_flag[x0][y0]) is signaled only for the 2N×2N partition. If the symmetry flag is asserted (i.e., having a value of 1), a symmetry type flag (i.e., symmetric_ibc_type[x0][y0]) is signaled.

TABLE 2

| coding_unit( x0, y0, log2CbSize ) { | Descriptor |
|---|---|
| ... | |
| } else if( intra_bc_flag[ x0 ][ y0 ] ) { | |
| if ( PartMode = = PART_2N×2N ){ | |
| symmetric_ibc_flag[x0][y0] | ae(v) |
| if(symmetric_ibc_flag[x0][y0]) | |
| symmetric_ibc_type[x0][y0] | ae(v) |
| } | |
| mvd_coding( x0, y0, 2) | |
| ... | |
| } | |
| } else { | |
| ... | |

It is desirable to develop methods to further improve the performance of coding system using the symmetric IntraBC technique.

### SUMMARY

A method and apparatus for video coding including an IntraBC (Intra-block copy) mode for a picture according to the present invention is disclosed. Embodiments of the present invention select an IntraBC mode from a mode group comprising a normal IntraBC mode and a flipping mode for a current PU with a current PU size belonging to a size group including at least one PU size selected from 2N×N, N×2N and N×N and N is a positive integer. When the flipping mode is used, a reference block is flipped before it is used as an IntraBC predictor. When the IntraBC mode is used for the current PU, a flipping flag is signaled in a current PU-level syntax to indicate whether the current PU is coded using the flipping mode. Furthermore, when the current PU is coded using the flipping mode, a flip-direction flag is signaled in the current PU-level syntax to indicate a flipping direction of a corresponding flipped reference block. The flipping flag and the flip-direction flag can be signaled in the current PU level syntax before or after a Merge flag.

To help reduce bit rate, the decision regarding whether the current PU is coded using the IntraBC mode can be derived based on a reference picture index. Therefore, there is no need to signal the IntraBC flag for indicating whether a corresponding PU is IntraBC coded. Also, the flip-direction flag to indicate a flipping direction of a corresponding flipped reference block can be inferred based on a partition mode for the current PU. Therefore, there is no need to signal the flip-direction flag. For example, when the partition mode is 2N×N or partitioned PU width is greater than partitioned PU height, the flipping direction is inferred to be vertical. Similarly, when the partition mode is N×2N or partitioned PU height is greater than partitioned PU width, the flipping direction is inferred to be horizontal. The flip-direction flag can also be inferred based on a decoded motion vector difference. For example, if only one component of the decoded motion vector difference is zero, the flipping direction follows a direction of non-zero component of the decoded motion vector difference.

One aspect of the invention addresses IntraBC prediction within the current CU. When the current CU is partitioned into multiple PUs using a partition mode, and a flipping flag is signaled for the current CU when the current CU is coded by the IntraBC mode, at least one of the multiple PUs is predicted by another PU of the multiple PUs according to the flipping mode. For example, if the partition mode corresponds to 2N×N, the top 2N×N PU of the current CU can be coded using the normal IntraBC mode and the bottom 2N×N PU of the current CU can be coded using the flipping mode with the vertical direction based on the top 2N×N PU. Similarly, if the partition mode corresponds to N×2N, the left N×2N PU of the current CU can be coded using the normal IntraBC mode and the right N×2N PU of the current CU can be coded using the flipping mode with the horizontal direction based on the left N×2N PU. If the partition mode corresponds to N×N, the top-left N×N PU of the current CU can be coded using the normal IntraBC mode and the top-right N×N PU of the current CU can be coded using the flipping mode with the horizontal direction based on the top-left N×N PU, and the bottom-left N×N PU and the bottom-right N×N PU of the current CU can be coded using the flipping mode with the vertical direction based on the top-left N×N PU and the top-right N×N PU respectively.

In the above case, IntraBC signaling related to the flipping mode may be able to identify the reference block. Therefore, the block vector signaling can be skipped to save bitrate. For example, when the current CU is partitioned into a top and bottom 2N×N PUs, a flipping flag is only signaled for the bottom 2N×N PU. If the flipping flag is True, the bottom 2N×N PU is coded using the flipping mode with a vertical direction based on the top 2N×N PU. Similarly, when the current CU is partitioned into a left and right N×2N PUs, a flipping flag is only signaled for the right N×2N PU. If the flipping flag is True, the right N×2N PU is coded using the flipping mode with a horizontal direction based on the left N×2N PU. When the current CU is partitioned into a top-left, top-right, bottom-left and bottom-right N×N PUs, a first flipping flag is signaled for the top-right N×N PU. If the first flipping flag is True, the top-right N×N PU is coded using the flipping mode with the horizontal direction based on the top-left N×N PU. A second flipping flag is signaled for the bottom-left or bottom-right N×N PU. If the second flipping flag is True, the bottom-left or bottom-right N×N PU is coded using the flipping mode with the vertical direction based on the top-left or top-right N×N PU respectively.

In another embodiment, the block vector (BV) signaling for the first PU in the current CU can also be skipped. When the current CU is partitioned into a top and bottom 2N×N PUs, a flipping flag can be signaled for the top 2N×N PU. If the flipping flag is True, the top 2N×N PU is coded using the flipping mode with the vertical direction based on an immediate above 2N×N block. When the current CU is partitioned into a left and right N×2N PUs, a flipping flag can be signaled for the left N×2N PU. If the flipping flag is True, the left N×2N PU is coded using the flipping mode with the horizontal direction based on an immediate left N×2N block. When the current CU is partitioned into a top-left, top-right, bottom-left and bottom-right N×N PUs, a flipping flag is signaled for the top-left N×N PU. If the flipping flag is True, the top-left N×N PU is either coded using the flipping mode with a horizontal direction based on an immediate left N×N block or coded using the flipping mode with a vertical direction based on an immediate top N×N block.

A flipping-control flag can be signaled in a SPS (sequence parameter set), a PPS (picture parameter set) or a slice header to indicate whether the flipping mode is allowed for a corresponding sequence, picture or slice respectively. Multiple flipping-control flags can be signaled in two or more levels of the SPS, the PPS and the slice header, a PPS flipping-control flag is signaled only when a SPS flipping-control flag is True. If the PPS flipping-control flag is not signaled, the PPS flipping-control flag will be inferred as False. A slice-level flipping-control flag will be signaled only when both the SPS flipping-control flag and the PPS flipping-control flag are True.

The current CU can be partitioned in 2N×2N, 2N×N, N×2N and N×N PUs. Furthermore, AMP (asymmetric motion partition) mode including 2N×nU, 2N×nD, nL×2N and nR×2N may also be used.

In yet another embodiment, the mode group further comprises a mask mode or both mask mode and combined mask and flipping mode. The IntraBC modes may consists of the normal IntraBC mode, flipping mode, mask mode, and combined mask and flipping mode. When the current PU size is N×N, the mask width can be fixed to be N/2 and no width syntax corresponding to the mask width is signaled, wherein N is an integer equal to 4 or larger. If a width syntax corresponding to the mask width is not signaled, the mask width can be inferred as N/2 and no width syntax corresponding to the mask width is signaled. In another embodiment, when the current PU size is N×N, the mask width can be N/2 or N/4 as indicated by a 1-bit selection flag, wherein N is an integer equal to 4 or larger. Other combinations of the PU size and the mask width are also disclosed.

### BRIEF DESCRIPTION OF THE DRAWINGS

FIG. 1 illustrates an example of Intra motion compensation according to the Intra-block copy (IntraBC) mode, where a horizontal displacement vector is used.

FIG. 2 illustrates an example of IntraBC with a flipping reference block.

FIG. 3A illustrates an example of symmetric IntraBC for N×2N partition.

FIG. 3B illustrates an example of symmetric IntraBC for 2N×N partition.

FIG. 3C illustrates an example of symmetric IntraBC for 2N×2N partition.

FIGS. 4A-4B illustrate examples of horizontal flipping.

FIGS. 4C-4D illustrate examples of vertical flipping.

FIG. 5 illustrates an example of IntraBC masking, where a sample is extending from a prediction unit (PU) boarder to fill a masked area.

FIG. 6 illustrates an example of variable-length binary tree for three IntraBC modes including normal IBC mode, mask only mode and flip only mode, where the normal IBC mode is assigned the shortest length bins.

FIG. 7 illustrates an example of variable-length binary tree for three IntraBC modes including normal IBC mode, mask only mode and flip only mode, where the mask only IBC mode is assigned the shortest length bins.

FIG. 8 illustrates an example of variable-length binary tree for three IntraBC modes including normal IBC mode, mask only mode and flip only mode, where the flip only IBC mode is assigned the shortest length bins.

FIG. 9 illustrates an example of variable-length binary tree for four IntraBC modes including normal IBC mode, mask only mode, flip only mode and both mask and flip mode, where the normal IBC mode is assigned the shortest length bins.

FIG. 10 illustrates an example of variable-length binary tree for four IntraBC modes including normal IBC mode, mask only mode, flip only mode and both mask and flip mode, where the flip only IBC mode is assigned the shortest length bins.

FIG. 11 illustrates an example of variable-length binary tree for four IntraBC modes including normal IBC mode, mask only mode, flip only mode and both mask and flip mode, where the mask only IBC mode is assigned the shortest length bins.

FIG. 12 illustrates an example of fixed-length binary tree for four IntraBC modes including normal IBC mode, mask only mode, flip only mode and both mask and flip mode.

FIG. 13 illustrates an exemplary flowchart for IntraBC coding utilizing flipping mode for predicting a current block according to an embodiment of the present invention.

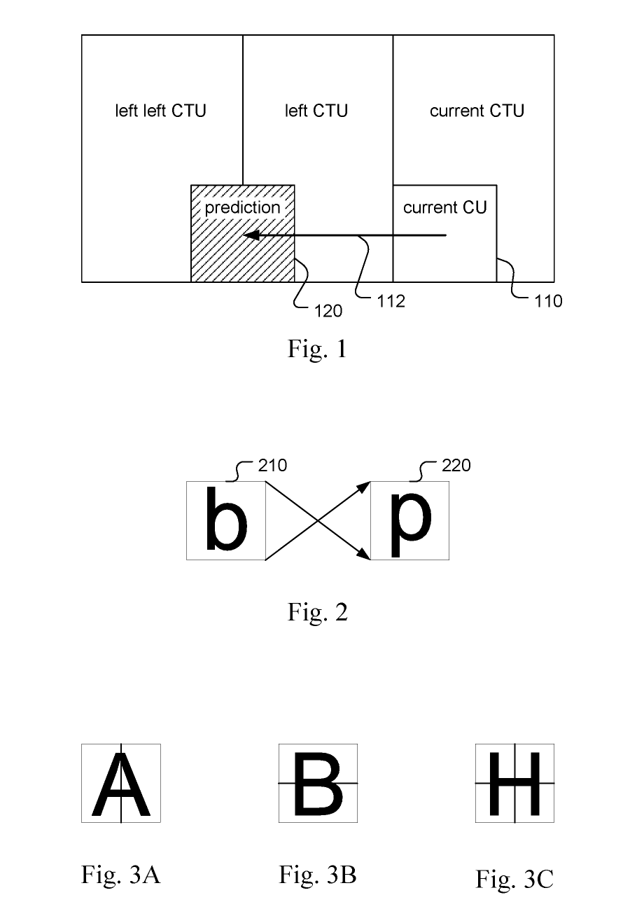

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

Various techniques according to the present invention to improve the performance of a coding system utilizing symmetric IntraBC coding are disclosed in this application.

### First Embodiment—IntraBC with Flipping within CU

In this embodiment, a flag is signaled at the CU level to indicate whether flipping is applied to prediction if this CU is IntraBC coded. When the partition mode is 2N×2N, IntraBC with flipping as described in JCTVC-Q0082 may be applied. If the partition mode is 2N×N and if the first 2N×N PU is IntraBC predicted, the first 2N×N PU can be coded using the method as disclosed in JCTVC-P0180. The second 2N×N PU can be predicted from the first 2N×N PU with vertical flipping. In other words, the first (most top) row of the first (top) 2N×N PU is used to predict the last (most bottom) row of the second (bottom) 2N×N PU., The second row of the first (top) 2N×N PU is used to predict the second last row of the second (bottom) 2N×N PU, and so on. No block vectors are needed to be searched and signaled for the second 2N×N PU. This is illustrated in the figure of FIG. 3B.

If the partition mode is N×2N and if the first N×2N PU is IntraBC predicted, then the first N×2N PU can be coded using the method as disclosed in JCTVC-P0180. The second N×2N PU can be predicted from the first N×2N PU with horizontal flipping. In other words, the first (most left) column of the first (left) N×2N PU is used to predict the last (most right) column of the second (right) N×2N PU. The second column of the first (left) N×2N PU is used to predict the second last column of the second (right) N×2N PU, and so on and so forth. No block vectors are needed to be searched and signaled for the second N×2N PU. This is illustrated in FIG. 3A.

If the partition mode is N×N and if the first (top left) N×N PU is IntraBC predicted, then the first N×N can be coded using the method described in JCTVC-P0180. The second (top right) N×N PU is predicted from the first N×N PU with horizontal flipping. The third (bottom left) and the fourth (bottom right) N×N PUs can be predicted from the first and the second N×N PUs, respectively, with vertical flipping. This is illustrated in FIG. 3C.

According to embodiments of the present invention, all or part of the partition modes including 2N×N, N×2N and N×N may be allowed. In all these scenarios, except for the first PU in the CU, no block vector needs to be derived or signaled. Therefore, the bitrate associated with BV signaling can be saved.

### Second Embodiment—IntraBC Flipping Across CU

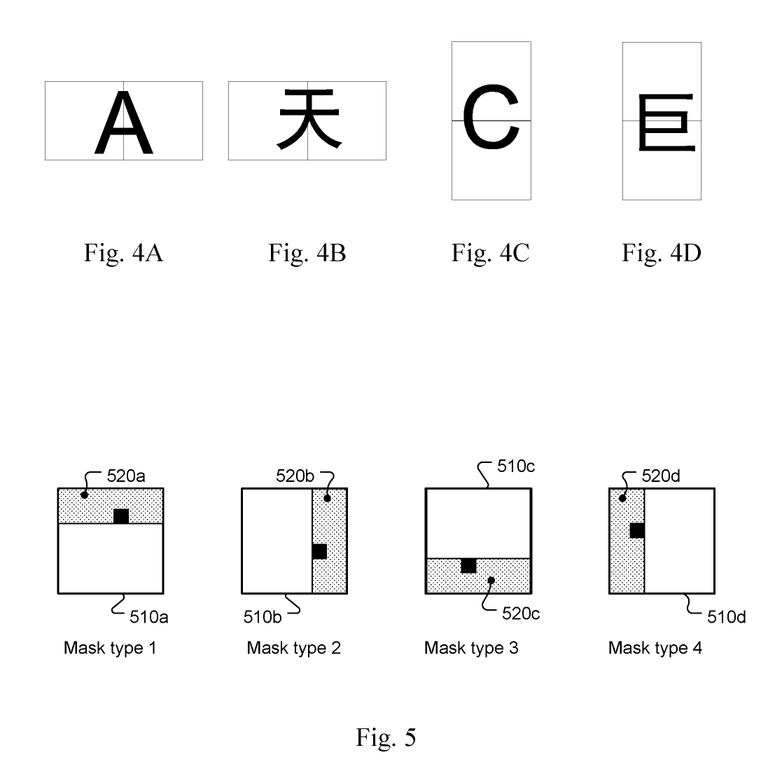

In another embodiment, a flag is signaled at the CU level to indicate whether flipping is applied for prediction when the CU is IntraBC coded. If the partition mode is 2N×2N, another flag is signaled to specify whether the vertical or horizontal flipping is used. If vertical flipping is used, then the equal size block above the current block, such as the top block in FIG. 4C and FIG. 4D, is used as the predictor. At the same time, vertical flipping is applied, i.e. the first (i.e., top) row of the reference block is used to predict the last (i.e., bottom) row of current block. The second row of the reference block is used to predict the second last row of the current block, and so on. If horizontal flipping is used, then the equal size block left to the current block, such as the left block in FIG. 4A and FIG. 4B, is used as the predictor. At the same time, horizontal flipping is applied, i.e. the first (i.e., left) column of the reference block is used to predict the last (i.e., right) column of current block, the second column of the reference block is used to predict the second last column of the current block, and so on. According to this embodiment, no block vectors need to be derived or signaled. The technique disclosed in this embodiment can be combined with the technique disclosed in the first embodiment disclosed above.

### Third Embodiment—IntraBC Flipping Signaled in the PU Syntax

In this embodiment, a flag is signal in the PU level to indicate whether the current PU is IntraBC coded with flipping. If the partition mode is 2N×2N, another flag can be signaled to specify whether vertical or horizontal flipping is used. The remaining process is the same as that disclosed in the second embodiment.

If the partition mode is 2N×N or N×2N, a flag is signaled in the second PU to indicate whether the PU is IntraBC coded with flipping. This flag is not signaled in the first PU. If the flag in the second 2N×N PU is True (i.e., asserted), then the second 2N×N PU is predicted from the first 2N×N PU with vertical flipping. The remaining process is the same as that disclosed in the first embodiment. If the flag in the second N×2N PU is True (i.e., asserted), then the second N×2N PU is predicted from the first N×2N PU with horizontal flipping. The remaining process is the same as that disclosed in the first embodiment. When the second PU is predicted using the IntraBC mode with flipping, there is no need to signal the block vector (BV). Therefore, the bitrate associated with BV signaling can be saved.

If the partition mode is N×N, a flag is signaled in the second (i.e., bottom-left block), third (i.e., top-right block) and fourth (i.e., bottom-right block) PUs to indicate whether the current PU is IntraBC coded with flipping. This flag is not signaled in the first PU (i.e., top-left block). If the flag in the second N×N PU is True (i.e., asserted), then the second N×N PU is predicted from the first N×N PU with vertical flipping. The remaining process is the same as that disclosed in the first embodiment. If the flag in the third or fourth N×N PU is True, then the third or fourth N×N PU is predicted from the first or second N×N PU with vertical flipping, respectively. When the second, the third and the fourth PUs are predicted using the IntraBC mode with flipping, there is no need to signal the block vector (BV). Therefore, the bitrate associated with BV signaling can be saved. The remaining process is the same as that disclosed in the first embodiment.

### Fourth Embodiment—IntraBC Flipping Signaled in PU Syntax

In another embodiment, a flag is signaled in both PUs to indicate whether the current PU is IntraBC coded with flipping when the partition mode is 2N×N or N×2N. If the flag in the first 2N×N PU is True, then the first 2N×N PU is predicted from its immediate above 2N×N block with vertical flipping. If the flag in the first N×2N PU is True, then the first N×2N PU is predicted from its immediate left N×2N block with horizontal flipping. If the flag in the second 2N×N or N×2N PU is True, then the process as disclosed in the third embodiment will be applied.

Similarly, a flag can be signaled in all PUs to indicate whether the current PU is IntraBC coded with flipping if the partition mode is N×N. If the flag in the first N×N PU is True, then the first N×N PU is predicted from either its immediate above N×N neighboring block or its immediate left neighboring block as specified by another flag. If the flag in the second, third and fourth PU is True, then the process as disclosed in the third embodiment will be applied.

Note that in this embodiment, no block vectors (BV) need to be derived or signaled for all PUs in the current CU when the PUs are coded using the IntraBC mode with flipping.

As disclosed above, according to the embodiments of the present invention, Intra block copy is also applied to partial coding unit (CU), i.e. PU in the context of HEVC. The PU may be 2N×N, N×2N or N×N in addition to 2N×2N. Furthermore, PU may also correspond to 2N×nU, 2N×nD, nL×2N and nR×2N in AMP (asymmetric motion partition) mode. Consequently, the partitions within a same CU may be coded in different modes such as Inter, IBC with flipping and IBC without flipping modes. In order to fulfill this mechanism, an embodiment is disclosed to signal the IBC flipping flag in each partition, i.e. in the PU syntax under the HEVC context.

For example, for each PU, if the PU is not coded by the Skip mode, then a flag (e.g. ibc_flag) can be signaled to indicate whether this PU is coded in the IBC mode. If it is, then a second flag (e.g. ibc_flip_flag) is signaled to indicate whether this PU is coded by IBC with flipping mode. If the second flag (i.e., ibc_flip_flag) is True, then another flag (e.g. ibc_flip_dir) is signaled to indicate the flipping direction as being vertical or horizontal. An exemplary PU-level syntax incorporating an embodiment as disclosed above is illustrated in Table 3.

TABLE 3

| prediction_unit( x0, y0, nPbW, nPbH ) { | Descriptor |
|---|---|
| if( cu_skip_flag[ x0 ][ y0 ] ) { | |
| if( MaxNumMergeCand > 1 ) | |
| merge_idx[ x0 ][ y0 ] | ae(v) |
| } else { /* MODE_INTER */ | |
| ibc_flag | ae(v) |
| if( ibc_flag ) { | |
| ibc_flip_flag | ae(v) |
| if( ibc_flip_flag ) | |
| ibc_flip_dir | ae(v) |
| mvd_coding( 0, 0, 2 ) | |
| } else { | |
| merge_flag[ x0 ][ y0 ] | ae(v) |
| if( merge_flag[ x0 ][ y0 ] ) { | |
| if( MaxNumMergeCand > 1 ) | |
| merge_idx[ x0 ][ y0 ] | ae(v) |
| } else { | |
| ... | |
| } | |
| } | |

In another example, the IBC and IBC flipping flags are signaled after the merge flag, as illustrated in Table 4.

TABLE 4

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

| | |
|---|---|
| } else { | |
| ibc_flag | ae(v) |
| if( ibc_flag ) { | |

| | |
|---|---|
| ibc_flip_flag | ae(v) |
| if( ibc_flip_flag ) | |
| ibc_flip_dir | ae(v) |
| mvd_coding( 0, 0, 2 ) | |

```
  } else {
  ...
}
```

}

In yet another example, the IBC mode can be derived from reference picture index (i.e., ref_idx). Therefore, the IBC flag (i.e., ibc_flag) to indicate the use of IBC mode is not needed. An exemplary syntax signaling according to this above example is illustrated in Table 5.

TABLE 5

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| merge_flag[ x0 ][ y0 ] | ae(v) |
| if( merge_flag[ x0 ][ y0 ] ) { | |
| if( MaxNumMergeCand > 1 ) | |

| | |
|---|---|
| merge_idx[ x0 ][ y0 ] | ae(v) |

} else {

| | |
|---|---|
| if( slice_type = = B ) | |
| inter_pred_idc[ x0 ][ y0 ] | ae(v) |

| | |
|---|---|
| if( inter_pred_idc[ x0 ][ y0 ] != PRED_L1 ) | |
| { | |
| if( num_ref_idx_l0_active_minus1 > 0 ) | |
| ref_idx_l0[ x0 ][ y0 ] | ae(v) |
| if( ref_idx_l0[ x0 ][ y0 ] == | |
| RFE_IDX_IBC) { | |
| ibc_flip_flag | ae(v) |
| if( ibc_flip_flag ) | |

| | |
|---|---|
| ibc_flip_dir | ae(v) |

}
mvd_coding( 0, 0, 0 )

...

}

In the above table, RFE_IDX_IBC is a specific value that is designated for signaling the use of IBC mode in this PU, the range for RFE_IDX_IBC is from 0 to (num_ref_idx_10 active_minus1+1), where (num_ref_idx_10_active_minus1+1) corresponds to the number of active reference pictures in the slice.

In yet another example, all PUs within one CU can only be either IBC with flipping or IBC without flipping mode. However, no normal Inter mode is allowed. In this case, an exemplary syntax signaling is shown in Table 6.

TABLE 6

Descriptor

Prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else if (intra_bc_flag[ x0 ][ y0 ]){ /* Intra BC*/

| | |
|---|---|
| ibc_flip_flag | ae(v) |
| if( ibc_flip_flag ) | |
| ibc_flip_dir | ae(v) |
| mvd_coding( x0, y0, 2) | |

```
  } else { /* MODE_INTER */
    ......
  }
}
```

In another example, the flipping direction may be inferred from the partition mode. Therefore, the flag “ibc_flip_dir” does not need to be coded.

In one embodiment, when the partition mode is 2N×N, or the PU is rectangle shape with width greater than height, the flipping direction is inferred to be vertical. When the partition mode is N×2N, or the PU is rectangle shape with height greater than width, the flipping direction is inferred to be horizontal. Under these circumstances, the following two lines can be removed from above tables.

| | |
|---|---|
| if( ibc_flip_flag ) | |
| ibc_flip_dir | ae(v) |

In another embodiment, the PU IBC flipping can be allowed only for 2N×2N, 2N×N and N×2N partitions, but not N×N partitions. In one specific case, IBC flipping is not applied to 4×4 blocks. Therefore, in the above syntax signaling examples, IBC flipping will not be coded when the partition mode is N×N or the partition size is 4×4.

In yet another embodiment, the IBC flipping direction (i.e., ibc_flip_dir) can be inferred from the decoded results of mvd_coding. If there is one and only one of two mvd components is zero, then the flipping direction follows the direction of the non-zero component. For example, if mvd_x is zero and mvd_y is non-zero, then the flipping direction is inferred to be vertical.

In yet another embodiment, the IBC flipping direction (i.e., ibc_flip_dir) can be inferred from the decoded results of mvd_coding, where mvd_coding corresponds to motion vector difference. If there is one and only one of two block vector (BV) components (i.e., x and y) is zero, then the flipping direction follows the direction of the non-zero component. For example, if bv_x is zero and bv_y is non-zero, then the flipping direction is inferred to be vertical (i.e., following the vertical direction).

In addition, a syntax flag may be used in high-level syntax such as SPS (sequence parameter set) or PPS (picture parameter set) or slice header to indicate whether IBC with flipping is allowed or not in the current video sequence, current picture or current slice, respectively. When they are used together, the PPS syntax flag is only signaled when the SPS syntax flag is True, i.e. IBC with flipping is enabled for the current sequence. Similarly, the slice syntax flag is only signaled when the SPS and PPS syntax flags are True, i.e. IBC with flipping is enabled for the current sequence and the current picture. When not signaled, the syntax flags are inferred as False.

In another embodiment, when IBC with flipping is not used, the syntax in Table 3 can be simplified to that illustrated in Table 7; the syntax is Table 4 can be simplified to that illustrated in Table 8.

TABLE 7

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| ibc_flag | ae(v) |
| if( ibc_flag ) { | |
| mvd_coding( 0, 0, 2 ) | |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

TABLE 8

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

| | |
|---|---|
| } else { | |
| ibc_flag | ae(v) |
| if( ibc_flag ) { | |

mvd_coding( 0, 0, 2 )

```
  } else {
  ...
}
```

}

IntraBC with Mask

An IntraBC coding technique with mask is disclosed in JCTVC-R0050 (Lainema et al., Non-SCCEJ: Intra block copy masking, Joint Collaborative Team on Video Coding (JCT-VC) of ITU-T SG16 WP3 and ISO/IEC JTC 1/SC 29/WG11 18th Meeting: Sapporo, JP, 30 Jun.-9 Jul. 2014, Document: JCTVC-R0050). In JCTVC-R0050, a mask is applied to the PUs coded in IntraBC mode. The mask covers a rectangular area extending from one of the borders of the PU and has a width varying from 1 to 3 sample rows or columns. All the sample values in the masked area are substituted with a single sample value obtained from the middle sample of the inner boundary of the masked area as shown in FIG. 5. Each PU is shown as a thick box (510a, 510b, 510c or 510d). The black samples in respective PU boards illustrate the location of the samples that the value of the black sample is used in the substitution process to fill the respective masked areas (520a, 520b, 520c or 520d) corresponding to mask types 1, 2, 3 and 4 respectively, as illustrated in FIG. 5.

In one embodiment, the mask is applied to both flipped and normal IntraBC blocks (e.g. PUs.) On the encoder side, the encoder first decides whether a video block (e.g. PU) is coded in the IntraBC mode, with or without flipping. A flag is signaled to specify whether to select the IntraBC mode (e.g. intra_bc_flag) and another flag (e.g. ibc_flip_flag) is signaled to specify whether to flip. Then the encoder decides whether mask (e.g. ibc_mask_flag) is applied to this IntraBC or IntraBC flipped video block. The block may correspond to a PU. On the decoder side, the decoder first parses a signal flag which specifies whether the current video block is coded by IntraBC. If the current video block is coded using the IntraBC mode, the decoder parses another signal flag which specifies whether the current IntraBC block is flipped. After that the decoder parses a mask flag which specifies whether the mask is applied to this IntraBC or IntraBC flipped video block. If the mask is applied, the decoder will parse the next flag, which defines the mask type (e.g. ibc_mask_type). The flag may be coded using a fixed length code (e.g. 2 bins). The decoder will parse the next flag and the next flag may be coded using a variable length code (e.g. 2 bins), which defines the mask width (e.g. ibc_mask_width). An exemplary syntax under the HEVC context is shown in Table 9.

TABLE 9

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| intra_bc_flag | ae(v) |
| if( intra_bc_flag ) { | |
| ibc_flip_flag | ae(v) |
| if( ibc_flip_flag ) | |

| | |
|---|---|
| ibc_flip_dir | ae(v) |

| | |
|---|---|
| mvd_coding( 0, 0, 2 ) | |
| ibc_mask_flag | ae(v) |
| if( ibc_mask_flag ) { | |

| | |
|---|---|
| ibc_mask_type | ae(v) |
| ibc_mask_width | ae(v) |

| | |
|---|---|
| } | |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

As mentioned above, the mask width has to be signaled when the mask mode is selected. Signaling the mask width will require bitrate and has impact on the coding efficiency. Embodiments according to the present invention eliminate the need for signaling the mask width or reduce the data required for signaling the mask width. For example, the mask width can be fixed to 2 when the block size is 4×4. In the context of HEVC extensions for screen content coding (SCC) when the IntraBC partition mode is N×N, the mask width can be fixed to N/2. Therefore, the flag “ibc_mask_width” is not signaled, and its value is inferred as 2 or (N/2).

In another variation, the mask width can be fixed to 1 when the block size is 4×4. In the context of HEVC extensions for screen content coding (SCC) when the IntraBC partition mode is N×N, the mask width is fixed to N/4. The flag “ibc_mask_width” is not signaled and its value is inferred as 1 or (N/4).

In yet another variation, the mask width may be 1 or 2 when the block size is 4×4. In the context of HEVC extensions for screen content coding (SCC) when the IntraBC partition mode is N×N, the mask width may be N/4 or N/2. The flag “ibc_mask_width” can be signaled by 1 bin to indicate whether the value is N/4 (1) or N/2 (2).

In yet another variation, the mask width can be fixed to 2 when the block size is 8×4 and the mask type is 1 or 3 or when the block size is 4×8 and the mask type is 2 or 4. In the context of HEVC extensions for screen content coding (SCC), when the IntraBC partition mode is 2N×N and the mask type is 1 or 3 or when the IntraBC partition mode is N×2N and the mask type is 2 or 4, the mask width can be fixed to N/2 if N is less or equal to 8. Under such circumstances, the flag “ibc_mask_width” is not signaled, and its value is inferred as 2 or (N/2).

In yet another variation, the mask width can be fixed to 1 when the block size is 8×4 and the mask type is 1 or 3, or when the block size is 4×8 and the mask type is 2 or 4. When the IntraBC partition mode is 2N×N and the mask type is 1 or 3, or when the IntraBC partition mode is N×2N and the mask type is 2 or 4, the mask width can be fixed to N/4 if N is less or equal to 8. Under such circumstances, the flag “ibc_mask_width” is not signaled, and its value is inferred as 1 or (N/4).

In yet another variation, the mask width may be 1 or 2 when the block size is 8×4 and the mask type is 1 or 3 or when the block size is 4×8 and the mask type is 2 or 4. When the IntraBC partition mode is 2N×N and the mask type is 1 or 3 or when the IntraBC partition mode is N×2N and the mask type is 2 or 4, the mask width may be N/4 or N/2 if N is less or equal to 8. Under such circumstances, the flag “ibc_mask_width” can be signaled by 1 bin to indicate whether the width is N/4 or N/2, or the value is 1 or 2.

In yet another variation, the mask width can be fixed to 2 when the block size is 8×4 and the mask type is 2 or 4, or when the block size is 4×8 and the mask type is 1 or 3. When the IntraBC partition mode is 2N×N and the mask type is 2 or 4 or when the IntraBC partition mode is N×2N and the mask type is 1 or 3, the mask width can be fixed to N/2 if N is less or equal to 8. Under such circumstances, the flag “ibc_mask_width” is not signaled, and its value is inferred as 2 or (N/2).

In yet another variation, the mask width can be fixed to 1 when the block size is 8×4 and the mask type is 2 or 4, or when the block size is 4×8 and the mask type is 1 or 3. When the IntraBC partition mode is 2N×N and the mask type is 2 or 4, or when the IntraBC partition mode is N×2N and the mask type is 1 or 3, the mask width can be fixed to N/4 if N is less or equal to 8. Under such circumstances, the flag “ibc_mask_width” is not signaled, and its value is inferred as 1 or (N/4).

In yet another variation, the mask width may be 1 or 2 when the block size is 8×4 and the mask type is 2 or 4, or when the block size is 4×8 and the mask type is 1 or 3. When the IntraBC partition mode is 2N×N and the mask type is 2 or 4, or when the IntraBC partition mode is N×2N and the mask type is 1 or 3, the mask width may be N/4 or N/2 if N is less or equal to 8. Under such circumstances, the flag “ibc_mask_width” can be signaled by 1 bin to indicate whether the width is N/4 or N/2, or the value is 1 or 2.

In yet another variation, when the block size is 8×4, the mask width can be fixed to 2 and the mask type can be 1 or 3; or when the block size is 4×8, the mask width can be fixed to 2 and the mask type can be 2 or 4. When the IntraBC partition mode is 2N×N, the mask type may be either 1 or 3 and the mask width can be fixed to N/2; or when the IntraBC partition mode is N×2N, the mask type may be 2 or 4 and the mask width can be fixed to N/2 if N is less or equal to 8. Under such circumstances, the flag “ibc_mask_width” is not signaled, and its value is inferred as 2 or (N/2). The flag “ibc_mask_type” can be signaled by 1 bin.

In yet another variation, when the block size is 8×4, the mask width can be fixed to 1 and the mask type may be 1 or 3; or when the block size is 4×8, the mask width can be fixed to 1 and the mask type may be 2 or 4. When the IntraBC partition mode is 2N×N, the mask type may be either 1 or 3 and the mask width can be fixed to N/4; or when the IntraBC partition mode is N×2N, the mask type may be 2 or 4 and the mask width can be fixed to N/4 if N is less or equal to 8. Under such circumstances, the flag “ibc_mask_width” is not signaled, and its value is inferred as 1 or (N/4). The flag “ibc_mask_type” can be signaled by 1 bin.

In yet another variation, when the block size is 8×4, the mask width may be 1 or 2 and the mask type may be 1 or 3; or when the block size is 4×8, the mask width may be 1 or 2 and the mask type may 2 or 4. When the IntraBC partition mode is 2N×N, the mask width may be N/4 or N/2 and the mask type may be 1 or 3; or when the IntraBC partition mode is N×2N, the mask width may be N/4 or N/2 and the mask type may be 2 or 4 if N is less or equal to 8. Under such circumstances, the flag “ibc_mask_width” can be signaled by 1 bin to indicate whether the width is (N/4) or (N/2), or the value is 1 or 2. The flag “ibc_mask_type” can be signaled by 1 bin.

In yet another variation, when the block size is 8×4, the mask width can be fixed to 2 and the mask type may be 2 or 4; or when the block size is 4×8, the mask width can be fixed to 2 and the mask type may be 1 or 3. When the IntraBC partition mode is 2N×N, the mask width can be fixed to N/2 and the mask type may be 2 or 4; or when the IntraBC partition mode is N×2N, the mask width can be fixed to N/2 and the mask type may be 1 or 3 if N is less or equal to 8. Under such circumstances, the flag “ibc_mask_width” is not signaled, and its value is inferred as 2, or (N/2). The flag “ibc_mask_type” can be signaled by 1 bin.

In yet another variation, when the block size is 8×4, the mask width can be fixed to 1 and the mask type may be 2 or 4; or when the block size is 4×8, the mask width can be fixed to 1 and the mask type may be 1 or 3. When the IntraBC partition mode is 2N×N, the mask width is fixed to N/4 and the mask type may be 2 or 4; or when the IntraBC partition mode is N×2N, the mask width can be fixed to N/4 and the mask type is either 1 or 3 if N is less or equal to 8. Under such circumstances, the flag “ibc_mask_width” is not signaled, and its value is inferred as 1, or (N/4). The flag “ibc_mask_type” can be signaled by 1 bin.

In yet another variation, when the block size is 8×4, the mask width may be 1 or 2 and the mask type may be 2 or 4; or when the block size is 4×8, the mask width may be 1 or 2 and the mask type may be 1 or 3. When the IntraBC partition mode is 2N×N, the mask width may be N/4 or N/2 and the mask type may be 2 or 4; or when the IntraBC partition mode is N×2N, the mask width may be N/4 or N/2 and the mask type may be 1 or 3 if N is less or equal to 8. Under such circumstances, the flag “ibc_mask_width” can be signaled by 1 bin to indicate whether the width is (N/4) or (N/2), or the value is 1 or 2. The flag “ibc_mask_type” can be signaled by 1 bin.

In yet another variation, 4 when the block size is 8×4, the mask type may be either 2 or 4; or when the block size is 4×8, the mask type may be 1 or 3. When the IntraBC partition mode is 2N×N, the mask type may be either 2 or 4; or when the IntraBC partition mode is N×2N, the mask type may be either 1 or 3. The flag “ibc_mask_type” can be signaled by 1 bin.

In yet another variation, when the block size is 8×4, the mask type may be 1 or 3; or when the block size is 4×8, the mask type may be 2 or 4. When the IntraBC partition mode is 2N×N, the mask type may be 1 or 3; or when the IntraBC partition mode is N×2N, the mask type may be either 2 or 4. The flag “ibc_mask_type” can be signaled by 1 bin.

In another embodiment, the AMP of IntraBC is extended to smaller blocks (e.g. CUs and PUs) than that is currently defined in HEVC. In other words, each side of AMP can be narrower than 4 pixels. Therefore AMP modes are allowed for CUs that are smaller than 16×16. In a specific example, AMP is allowed for 8×8 CUs, where the two partitions can be 8×2 and 8×6, or 2×8 and 6×8. In some hardware designs PUs with a side less than 4 pixels wide is not desired due to the extra memory bandwidth cost. Therefore, IntraBC mask is applied to small (e.g. smaller than 16×16) IntraBC blocks with AMP according to one embodiment. In another embodiment, the partition mode of IntraBC AMP is signaled in the same way as Inter AMP, including for small blocks, such as 8×8 which results in two partitions 8×2 and 8×6, or 2×8 and 6×8. However when the AMP includes small blocks, the mask method is applied. For larger size blocks (e.g. blocks/CUs equal to or greater than 16×16), normal Intra process can be applied. In this case, for smaller-block IntraBC with AMP, only one BV is signaled and used. The BV represents the distance between the current block (e.g. CU) and the reference block. In normal IntraBC process with AMP, two BVs are signaled, which represent the distance between each PU and its reference in the current block (or CU.)

Examples of partition mode binarization according to one embodiment are show in Table 10 and Table 11.

TABLE 10

| part_mode | PartMode | Bin string |
|---|---|---|
| 0 | PART_2Nx2N | 1 |
| 1 | PART_2NxN | 011 |
| 2 | PART_Nx2N | 0011 |
| 3 | PART_NxN | 0001 |
| 4 | PART_2NxnU | 0100 |
| 5 | PART_2NxnD | 0101 |
| 6 | PART_nLx2N | 00100 |
| 7 | PART_nRx2N | 00101 |

TABLE 11

| part_mode | PartMode | Bin string |
|---|---|---|
| 0 | PART_2Nx2N | 1 |
| 1 | PART_Nx2N | 011 |
| 2 | PART_2NxN | 0011 |
| 3 | PART_NxN | 0001 |
| 4 | PART_nLx2N | 0100 |
| 5 | PART_nRx2N | 0101 |
| 6 | PART_2NxnU | 00100 |
| 7 | PART_2NxnD | 00101 |

The above embodiment can also be applied to Inter picture prediction. For example, under the context of HEVC and HEVC extensions for Range and HEVC extensions on Range, the CU syntax can be modified as shown in Table 12, where the additional syntax indicated by notes (12-1) and (12-2).

TABLE 12

| | |
|---|---|
| Descriptor | Note |

coding_unit( x0, y0, log2CbSize ) {

...
if( CuPredMode[ x0 ][ y0 ] != MODE_INTRA
| |

log2CbSize = = MinCbLog2SizeY )

| | |
|---|---|
| part_mode | ae(v) |
| if( CuPredMode[ x0 ][ y0 ] = = | |
| MODE_INTRA ) { | |
| ... | |
| } else { | |
| if( PartMode = = PART_2Nx2N ) | |

prediction_unit( x0, y0, nCbS, nCbS )

else if( PartMode = = PART_2NxN ) {

prediction_unit( x0, y0, nCbS, nCbS / 2 )
prediction_unit( x0, y0 + ( nCbS / 2 ),
nCbS, nCbS / 2 )

} else if( PartMode = = PART_Nx2N ) {

prediction_unit( x0, y0, nCbS / 2, nCbS )
prediction_unit( x0 + ( nCbS / 2 ), y0,
nCbS / 2, nCbS )

| | |
|---|---|
| else if( log2CbSize = = MinCbLog2SizeY && | 12-1 |

PartMode != PART_NxN )

| | |
|---|---|
| prediction_unit( x0, y0, nCbS, nCbS ) | 12-2 |

} ...

.../*same syntax as these for AMP*/

}
}
......

}
}

Another aspect of the present invention addresses coding mode signaling for Inter and IntraBC mode (with or without flipping and other combinations).

Variable-Length IBC Signaling for 3 IntraBC Modes in PU Level

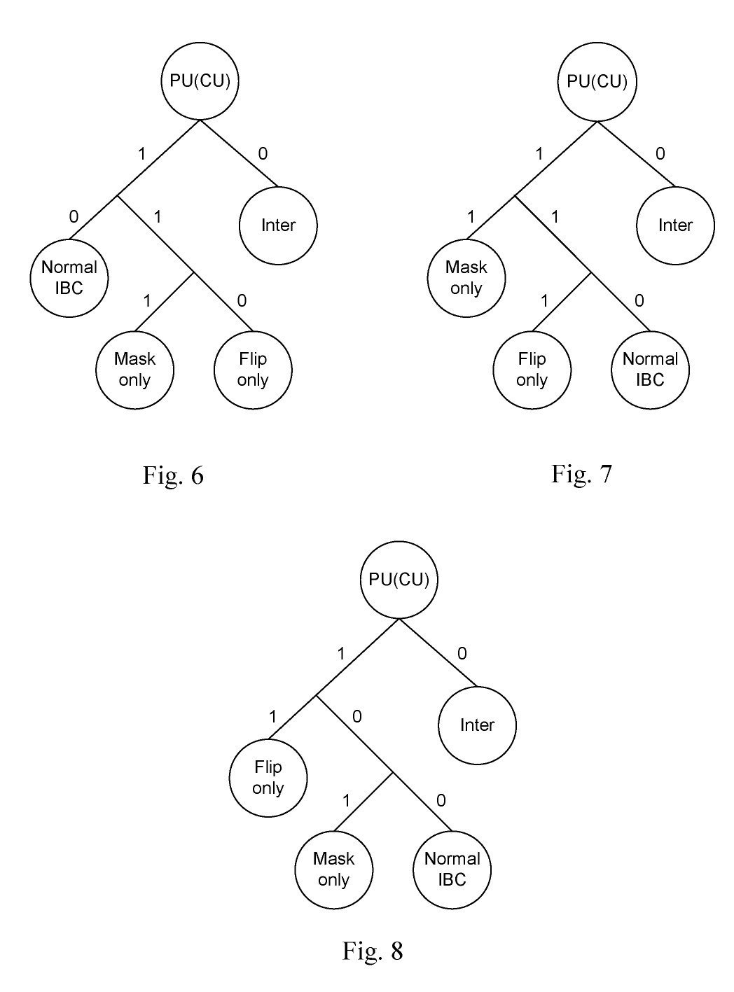

Various embodiments of the present invention are disclosed for PU-level syntax design to support various IntraBC modes. In one embodiment, the IntraBC modes allowed include the normal IntraBC mode, IntraBC mode with flipping only (i.e., flipping mode), and IntraBC mode with mask only (i.e., mask mode). Each syntax design can be associated with a mode decision tree (Inter mode and IntraBC modes). Three binary decision trees are illustrated in FIG. 6 through FIG. 8. As shown in FIGS. 6-8, the first bin is used to differentiate an IntraBC mode (i.e., “1” bit) from the Inter mode (i.e., “0” bit). Furthermore, variable length codes with a maximum length of 2 bits are used to represent the three individual IntraBC modes. The corresponding PU-level syntax designs are shown in Tables 13-15.

TABLE 13

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| intra_bc_flag | ae(v) |
| if( intra_bc_flag ) { | |
| ibc_flip_mask_flag | ae(v) |
| if( ibc_flip_mask_flag ) { | |

| | |
|---|---|
| ibc_mask_flag | ae(v) |
| if( ibc_mask_flag ) { | |
| ibc_mask_type | ae(v) |
| ibc_mask_width | ae(v) |
| } | |
| else | |
| ibc_flip_dir | ae(v) |

| | |
|---|---|
| } | |
| bvd_coding( 0, 0, 2 ) | |
| bvp_flag | ae(v) |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

TABLE 14

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[x0][y0] | ae(v) |

} else { /* MODE_INTER */

| | |
|---|---|
| intra_bc_flag | ae(v) |
| if( intra_bc_flag ) { | |
| ibc_mask_flag | ae(v) |
| if( ibc_mask_flag ) { | |

| | |
|---|---|
| ibc_mask_type | ae(v) |
| ibc_mask_width | ae(v) |
| } | |

| | |
|---|---|
| else{ | |
| ibc_flip_flag | ae(v) |

if(ibc_flip_flag)

| | |
|---|---|
| ibc_flip_dir | ae(v) |

| | |
|---|---|
| } | |
| bvd_coding( 0, 0, 2 ) | |
| bvp_flag | ae(v) |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

TABLE 15

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| intra_bc_flag | ae(v) |
| if( intra_bc_flag ) { | |
| ibc_flip_flag | ae(v) |
| if( ibc_flip_flag ) | |

| | |
|---|---|
| ibc_flip_dir | ae(v) |

else{

| | |
|---|---|
| ibc_mask_flag | ae(v) |
| if( ibc_mask_flag ) { | |
| ibc_mask_type | ae(v) |
| ibc_mask_width | ae(v) |
| } | |

| | |
|---|---|
| } | |
| bvd_coding( 0, 0, 2 ) | |
| bvp_flag | ae(v) |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

Variable-Length IBC Signaling for 4 IntraBC Modes in PU Level

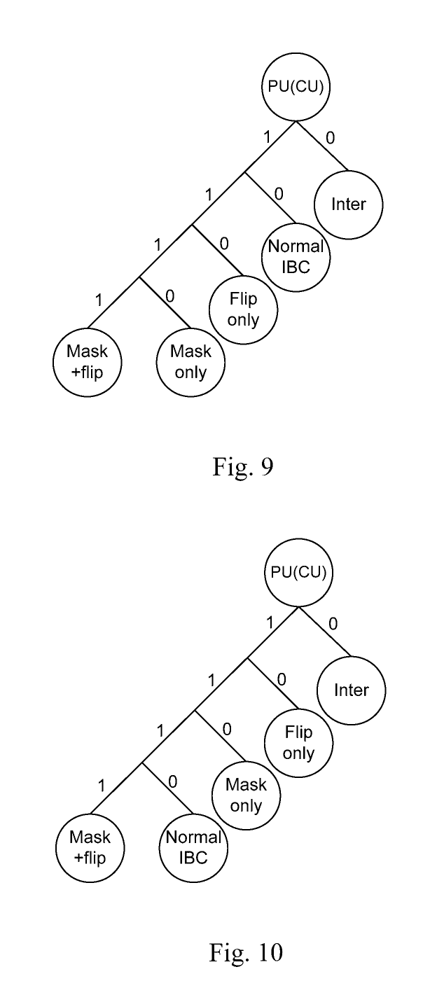

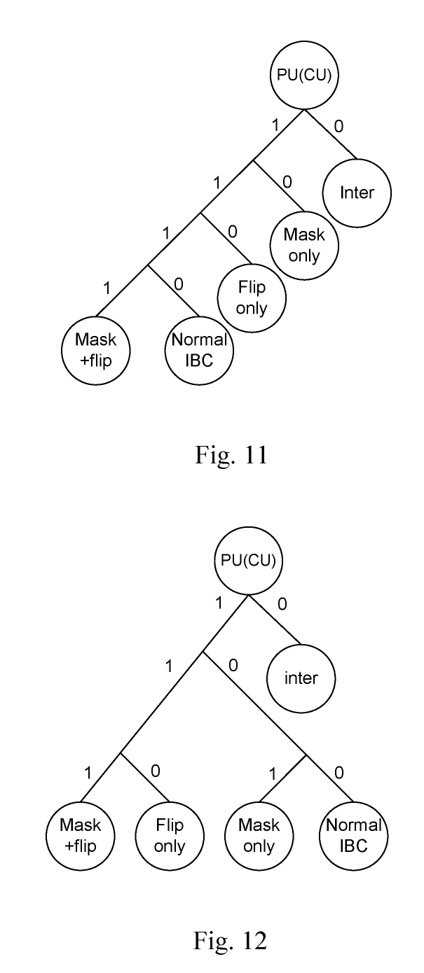

In another embodiment, the IntraBC modes allowed include the normal IntraBC mode, IntraBC mode with flipping only (i.e., flipping mode), and IntraBC mode with mask only (i.e., mask mode), and IntraBC mode with both mask and flipping (i.e., combined mask and flipping mode). Each syntax design can be associated with a mode decision tree (Inter mode and IntraBC modes). Three binary decision trees are illustrated in FIG. 9 through FIG. 11. As shown in FIGS. 9-11, the first bin is used to differentiate an IntraBC mode (i.e., “1” bit) from the Inter mode (i.e., “0” bit). Furthermore, variable length codes with a maximum length of 3 bits are used to represent the four individual IntraBC modes. The corresponding PU-level syntax design for FIG. 9 is shown in Tables 16.

TABLE 16

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| intra_bc_flag | ae(v) |
| if( intra_bc_flag ) { | |
| ibc_flip_mask_flag | ae(v) |
| if(ibc_flip_mask_flag) { | |

| | |
|---|---|
| ibc_mask_flag | ae(v) |
| if( ibc_mask_flag ) { | |
| ibc_flipping _flag | ae(v) |
| if ( ibc_flipping_flag ) | |

| | |
|---|---|
| ibc_flip_dir | ae(v) |
| ibc_mask_type | ae(v) |
| ibc_mask_width | ae(v) |

| | |
|---|---|
| } | |
| else | |
| ibc_flip_dir | ae(v) |

| | |
|---|---|
| } | |
| bvd_coding( 0, 0, 2 ) | |
| bvp_flag | ae(v) |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

While various examples of variable length binary trees are demonstrated for syntax design to accommodate multiple Intra modes, these example are not meant for providing an exhaustive lists of all possible binary codes. A person skilled in the art may practice the present invention using similar binary trees to design corresponding PU-level syntax.

Fixed-Length IBC Signaling for 4 IntraBC Modes in PU Level

In another embodiment, the IntraBC modes allowed include the normal IntraBC mode, IntraBC mode with flipping only, and IntraBC mode with mask only, and IntraBC mode with both mask and flipping. Two-bit fixed length codes are used to represent the four IntraBC modes as shown in FIG. 12. The corresponding PU-level syntax design under the HEVC context is shown in Table 17.

TABLE 17

Descriptor

prediction_unit( x0, y0, nPbW, nPbH ) {
if( cu_skip_flag[ x0 ][ y0 ] ) {

| | |
|---|---|
| if( MaxNumMergeCand > 1 ) | |
| merge_idx[ x0 ][ y0 ] | ae(v) |

} else { /* MODE_INTER */

| | |
|---|---|
| intra_bc_flag | ae(v) |
| if( intra_bc_flag ) { | |
| ibc_flip_flag | ae(v) |
| if( ibc_flip_flag ) | |

| | |
|---|---|
| ibc_flip_dir | ae(v) |
| ibc_mask_flag | ae(v) |
| if( ibc_mask_flag ) { | |
| ibc_mask_type | ae(v) |
| ibc_mask_width | ae(v) |
| } | |

| | |
|---|---|
| } | |
| bvd_coding( 0, 0, 2 ) | |
| bvp_flag | ae(v) |
| } else { | |
| merge_flag[ x0 ][ y0 ] | ae(v) |
| if( merge_flag[ x0 ][ y0 ] ) { | |

| | |
|---|---|
| if( MaxNumMergeCand > 1 ) | |
| merge_idx[ x0 ][ y0 ] | ae(v) |

} else {
...
}

}

The performance of a system incorporating an embodiment of the present invention is compared to an anchor system based of SCM2.0 software (Screen Content Coding Test Model version 2.0). The system incorporating an embodiment of the present invention allows IntraBC coding with flipping for all PU partitions including 2N×2N, 2N×N, N×2N and N×N. If a current PU is coded in the IntraBC mode, a flipping flag and a flipping direction flag are further signaled. On the other hand, SCM 2.0 does not support PU-level IntraBC with flipping. The test is conducted under common test condition (CTC) for screen content coding (SCC) with the full picture IBC search range. The performance comparisons in terms of BD-Rate are summarized as follows for different test materials, where the BD-Rate is a well-known performance measure in the field of video coding. A negative value indicates the system according to the present invention outperforming the anchor system. Based on the comparison, the system incorporating an embodiment of the present achieves RD-Rate reduction up to 2.2%.

In yet another comparison, in the system incorporating an embodiment of the present invention, the PUs in a CU are all coded using an IntraBC mode with flipping or all use a normal IntraBC mode when an IntraBC mode is selected for the CU. Again, the anchor system is based on SCM2.0. Based on the comparison, the system incorporating an embodiment of the present achieves RD-Rate reduction up to 1.4%. When an embodiment further includes the mask, the performance is slightly further improved.

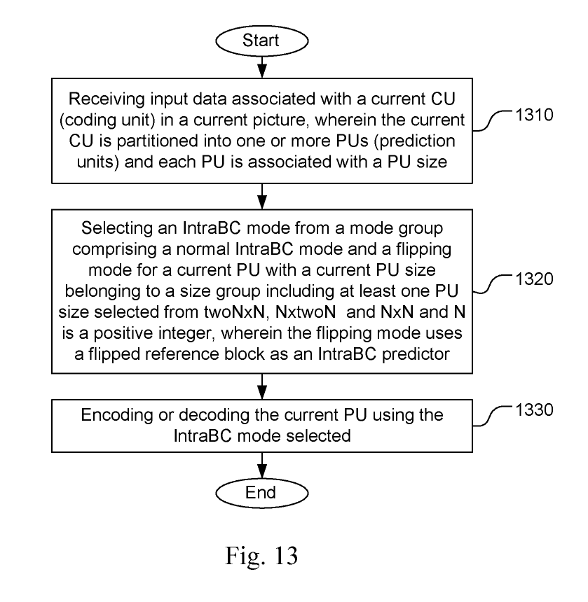

FIG. 13 illustrates an exemplary flowchart for IntraBC coding utilizing IntraBC mode with flipping for non-2N×2N PU according to an embodiment of the present invention. The system receives input data associated with a current CU (coding unit) in a current picture as shown in step 1310. For encoding, the input data corresponds to pixel data to be encoded. For decoding, the input data corresponds to coded pixel data to be decoded. The input data may be retrieved from memory (e.g. computer memory, buffer (RAM or DRAM) or other media) or from a processor. The current CU is partitioned into one or more PUs (prediction units) and each PU is associated with a PU size. An IntraBC mode is selected from a mode group comprising a normal IntraBC mode and a flipping mode for a current PU with a current PU size belonging to a size group including at least one PU size selected from 2N×N, N×2N and N×N and N is a positive integer as shown in step 1320. The flipping mode uses a flipped reference block as an IntraBC predictor. The current PU is then encoded or decoded using the IntraBC mode selected as shown in step 1330.

The flowchart shown above is intended to illustrate an example of IntraBC coding according to the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding including an IntraBC (Intra-block copy) mode for a picture, the method comprising:
receiving input data associated with a current CU (coding unit) in a current picture, wherein the current CU is partitioned into one or more PUs (prediction units) and each PU is associated with a PU size;
selecting an IntraBC mode from a mode group comprising a normal IntraBC mode and a flipping mode for a current PU with a current PU size belonging to a size group including at least one PU size selected from 2N×N, N×2N and N×N and N is a positive integer, wherein the flipping mode uses a flipped reference block as an IntraBC predictor; and
encoding or decoding the current PU using the IntraBC mode selected.

2. The method of claim 1, wherein when the IntraBC mode is used for the current PU, a flipping flag is signaled in a current PU-level syntax to indicate whether the current PU is coded using the flipping mode.

3. The method of claim 2, wherein when the current PU is coded using the flipping mode, a flip-direction flag is signaled in the current PU-level syntax to indicate a flipping direction of a corresponding flipped reference block.

4.-6. (canceled)

7. The method of claim 2, wherein a flip-direction flag to indicate a flipping direction of a corresponding flipped reference block is inferred based on a partition mode for the current PU and no flip-direction flag is signaled for the current PU.

8.-11. (canceled)

12. The method of claim 1, wherein when the current CU is partitioned into multiple PUs using a partition mode, and a flipping flag is signaled for the current CU when the current CU is coded by the IntraBC mode, at least one of said multiple PUs is predicted by another PU of said multiple PUs according to the flipping mode.

13. The method of claim 12, wherein if the partition mode corresponds to 2N×N, a top 2N×N PU of the current CU is coded using the normal IntraBC mode and a bottom 2N×N PU of the current CU is coded using the flipping mode with a vertical direction based on the top 2N×N PU.

14. The method of claim 12, wherein if the partition mode corresponds to N×2N, a left N×2N PU of the current CU is coded using the normal IntraBC mode and a right N×2N PU of the current CU is coded using the flipping mode with a horizontal direction based on the left N×2N PU.

15. The method of claim 12, wherein if the partition mode corresponds to N×N, a top-left N×N PU of the current CU is coded using the normal IntraBC mode and a top-right N×N PU of the current CU is coded using the flipping mode with a horizontal direction based on the top-left N×N PU, and a bottom-left N×N PU and a bottom-right N×N PU of the current CU is coded using the flipping mode with a vertical direction based on the top-left N×N PU and the top-right N×N PU respectively.

16. The method of claim 1, wherein when the current CU is partitioned into a top 2N×N PU and a bottom 2N×N PU, a flipping flag is only signaled for the bottom 2N×N PU, and if the flipping flag is True, the bottom 2N×N PU is coded using the flipping mode with a vertical direction based on the top 2N×N PU.

17. The method of claim 1, wherein when the current CU is partitioned into a left N×2N PU and a right N×2N PU, a flipping flag is only signaled for the right N×2N PU, and if the flipping flag is True, the right N×2N PU is coded using the flipping mode with a horizontal direction based on the left N×2N PU.

18. The method of claim 1, wherein when the current CU is partitioned into a top-left N×N PU, a top-right N×N PU, a bottom-left N×N PU and a bottom-right N×N PU, wherein a first flipping flag is signaled for the top-right N×N PU, and if the first flipping flag is True, the top-right N×N PU is coded using the flipping mode with a horizontal direction based on the top-left N×N PU, and wherein a second flipping flag is signaled for the bottom-left N×N PU or the bottom-right N×N PU, and if the second flipping flag is True, the bottom-left N×N PU or the bottom-right N×N PU is coded using the flipping mode with a vertical direction based on the top-left N×N PU or the top-right N×N PU respectively.

19. The method of claim 1, wherein when the current CU is partitioned into a top 2N×N PU and a bottom 2N×N PU, a first flipping flag is signaled for the top 2N×N PU and a second flipping flag is signaled for the bottom 2N×N PU, wherein if the first flipping flag is True, the top 2N×N PU is coded using the flipping mode with a vertical direction based on an immediate above 2N×N block, and wherein if the second flipping flag is True, the bottom 2N×N PU is coded using the flipping mode with the vertical direction based on the top 2N×N PU.

20. The method of claim 1, wherein when the current CU is partitioned into a left N×2N PU and a right N×2N PU, a first flipping flag is signaled for the left N×2N PU and a second flipping flag is signaled for the right N×2N PU, wherein if the first flipping flag is True, the left N×2N PU is coded using the flipping mode with a horizontal direction based on an immediate left N×2N block, and wherein if the second flipping flag is True, the right N×2N PU is coded using the flipping mode with the horizontal direction based on the left N×2N PU.

21. The method of claim 1, wherein when the current CU is partitioned into a top-left N×N PU, a top-right N×N PU, a bottom-left N×N PU and a bottom-right N×N PU, wherein a first flipping flag is signaled for the top-left N×N PU, and if the first flipping flag is True, the top-left N×N PU is either coded using the flipping mode with a horizontal direction based on an immediate left N×N block or coded using the flipping mode with a vertical direction based on an immediate top N×N block, and wherein the top-right N×N PU, the bottom-left N×N PU and the bottom-right N×N PU are coded using the flipping mode based on a previous coded N×N PU in the current CU if a corresponding flipping flag is True.

22.-30. (canceled)

31. The method of claim 1, wherein the mode group further comprises a mask mode, wherein a masked area within a corresponding reference block is generated by substituting mask samples in the masked area with a single sample value and the masked area has a mask width.

32. The method of claim 31, wherein when the IntraBC mode is used for the current PU, a mask flag is signaled before a flipping flag in a current PU-level syntax, wherein the flipping flag indicates whether the current PU is coded using the flipping mode and the mask flag indicates whether the current PU is coded using the mask mode.

33. The method of claim 31, wherein when the IntraBC mode is used for the current PU, a mask flag is signaled after a flipping flag in a current PU-level syntax, wherein the flipping flag indicates whether the current PU is coded using the flipping mode and the mask flag indicates whether the current PU is coded using the mask mode.

34. The method of claim 31, wherein the mode group further comprises a combined mask and flipping mode.

35. The method of claim 34, wherein the mode group includes four IntraBC modes corresponding to the normal IntraBC mode, the flipping mode, the mask mode and the combined mask and flipping mode, and wherein said selecting the IntraBC mode from the mode group is according to a variable-length binary decision tree consisting of the four IntraBC modes.

36.-43. (canceled)

44. An apparatus of video coding including an IntraBC (Intra-block copy) mode for a picture, the apparatus comprising one or more electronic circuits configured to:
receive input data associated with a current CU (coding unit) in a current picture, wherein the current CU is partitioned into one or more PUs (prediction units) and each PU is associated with a PU size;
select an IntraBC mode from a mode group comprising a normal IntraBC mode and a flipping mode for a current PU with a current PU size belonging to a size group including at least one PU size selected from 2N×N, N×2N and N×N and N is a positive integer, wherein the flipping mode uses a flipped reference block as an IntraBC predictor; and
encode or decode the current PU using the IntraBC mode selected.
